(19) United States
(12) Patent Application Publication
(10) Pub. No.: US 2019/0236127 A1
(43) Pub. Date: Aug. 1, 2019

(54) GENERATING A MODIFIED EVIDENCING ELECTRONIC DOCUMENT INCLUDING MISSING ELEMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 16/377,818

(22) Filed: Apr. 8, 2019

Related U.S. Application Data
(63) Continuation of application No. PCT/US2018/013489, filed on Jan. 12, 2018.
(60) Provisional application No. 62/445,248, filed on Jan. 12, 2017.

(51) Int. Cl. G06F 17/24; G06F 16/338; G06F 16/35; G06K 9/00; G06Q 40/00

(52) U.S. Cl. CPC G06F 17/248; G06F 16/338; G06Q 40/10; G06K 9/00483; G06K 9/00456; G06F 16/35

(57) ABSTRACT

A system and method for generating a modified evidencing electronic document including missing elements based on an electronic document including at least partially unstructured data. The method includes: analyzing the electronic document to determine at least one transaction parameter; creating a template for the electronic document, where the template is a structured dataset including the at least one transaction parameter; determining, based on the template, whether the electronic document meets at least one evidencing requirement; identifying at least one missing parameter based on a matching record when it is determined that the electronic document does not meet the at least one evidencing requirement; and generating the modified evidencing electronic document including the identified at least one missing parameter.

### CROSS-REFERENCE TO RELATED APPLICATIONS

This application is a continuation of International Application PCT/US2018/013489 filed Jan. 12, 2018, which claims the benefit of U.S. Provisional Application No. 62/445,248 filed on Jan. 12, 2017.

The contents of the above-referenced applications are hereby incorporated by reference.

### TECHNICAL FIELD

The present disclosure relates generally to modifying an evidencing electronic document, and more particularly to modifying an evidencing electronic document to include missing required elements.

### BACKGROUND

Enterprises all over the world often spend large amounts of money on goods and services purchased by the enterprises' employees in the course of regular business. Portions of these transactions may be refundable such that, for example, the enterprise can reclaim a value added tax (VAT) or deduct qualified expenses from a corporate income tax (CIT). Such expenses may be reported to the relevant tax authorities in order to reclaim at least a partial tax refund for the expenses made.

The VAT is a consumption tax paid on purchases of products in certain countries that is based on the increases in value of the purchased product at each stage of its production or distribution. VAT taxes paid on some types of goods may be refunded depending on the jurisdiction in which the purchase is made. The CIT is a tax on the profits of corporations in the United States of America that is equal to a corporation's receipts less allowable deductions such as costs of goods sold, wages paid and other employee compensations, paid interest, certain taxes, depreciation, and advertising costs.

In many cases, to obtain a refund or deduction, the enterprise is required to provide evidencing documents to the tax authority such as receipts, invoices, and the like, associated with the expenses made. These evidencing documents may need to be submitted along with a statement of the relevant parameters for the transaction such as the date, time, types of goods purchased, and the like. A report including the evidences and any necessary statements is prepared and provided to appropriate tax authorities to obtain the refund.

In order to receive the full tax benefit for business expenses, the evidencing documents must include certain elements, which may differ from one jurisdiction to another. Therefore, in case an evidencing documents does not include a necessary element, it cannot be used for a successful refund or deduction.

Currently, when a necessary element is missing from one or more evidencing documents, e.g., receipts, a request to reissue the document is sent to an entity (e.g., a supplier of purchased goods) that originally issued the evidence. This request can be time consuming for both the issuing entity and the requesting entity. One popular, though expensive, solution is to hire the services of an accounting firm to handle this important financial matter.

Some solutions exist for automatically managing evidencing documents to ensure compliance with jurisdictional rules. However, these solutions can, at best, send the request to a predetermined recipient which may not efficiently return the reissued document. Further, such solutions may not efficiently or accurately identify missing elements, particularly when the evidencing documents are in the form of unstructured documents such as scans of receipts or invoices. Often, the more effort required to respond to a reissue request of an evidencing document, the less likely the response will be completed and returned in a timely manner. Thus, submitting a request for reissuance without providing the exact missing elements needed to be modified can become a cumbersome task for a reissuing entity.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a modified evidencing electronic document including missing elements based on an electronic document including at least partially unstructured data. The method includes: analyzing the electronic document to determine at least one transaction parameter; creating a template for the electronic document, where the template is a structured dataset including the at least one transaction parameter; determining, based on the template, whether the electronic document meets at least one evidencing requirement; identifying at least one missing parameter based on a matching record when it is determined that the electronic document does not meet the at least one evidencing requirement; and generating the modified evidencing electronic document including the identified at least one missing parameter.

Certain embodiments disclosed herein also include a non-transitory computer readable medium having stored thereon causing a processing circuitry to execute a process, the process comprising: analyzing the electronic document to determine at least one transaction parameter; creating a template for the electronic document, where the template is a structured dataset including the at least one transaction parameter; determining, based on the template, whether the electronic document meets at least one evidencing requirement; identifying at least one missing parameter based on a matching record when it is determined that the electronic document does not meet the at least one evidencing requirement; and generating the modified evidencing electronic document including the identified at least one missing parameter.

Certain embodiments disclosed herein also include a system for generating a modified evidencing electronic document including missing elements based on an electronic document including at least partially unstructured data. The system includes: a processing circuitry; and a memory, the memory containing instructions that, when executed by the processing circuitry, configure the system to: analyze the electronic document to determine at least one transaction parameter; create a template for the electronic document, where the template is a structured dataset including the at least one transaction parameter; determine, based on the template, whether the electronic document meets at least one evidencing requirement; identify at least one missing parameter based on a matching record when it is determined that the electronic document does not meet the at least one evidencing requirement; and generate the modified evidencing electronic document including the identified at least one missing parameter.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an evidence modifier according to an embodiment.

FIG. 3 is a flowchart illustrating a method for modifying an evidencing electronic document according to an embodiment.

FIG. 4 is a flowchart illustrating a method for creating a structured dataset template based on an electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for modifying an evidencing electronic document to include missing necessary parameters. An evidencing electronic document is analyzed to determine whether it meets one or more evidencing requirements. When it is determined that the evidencing electronic document does not meet one or more of the evidencing requirements, a matching record (e.g., a record electronic document or purchase record dataset) is identified. The evidencing electronic document is compared to the matching record, and one or more of the missing evidencing requirements is identified within the matching record. A modified evidencing electronic document including the missing evidencing requirements is generated. The modified evidencing electronic document may be sent to a reissuing entity for a reissuance request.

In an embodiment, the evidencing electronic document, or evidence, is an at least partially unstructured document. A template is created based on the at least partially unstructured electronic document. The template is a structured dataset including transaction parameters, and is created based on key fields and values identified in the evidencing electronic document. The structured dataset template allows for more efficient and accurate processing of transaction parameter data.

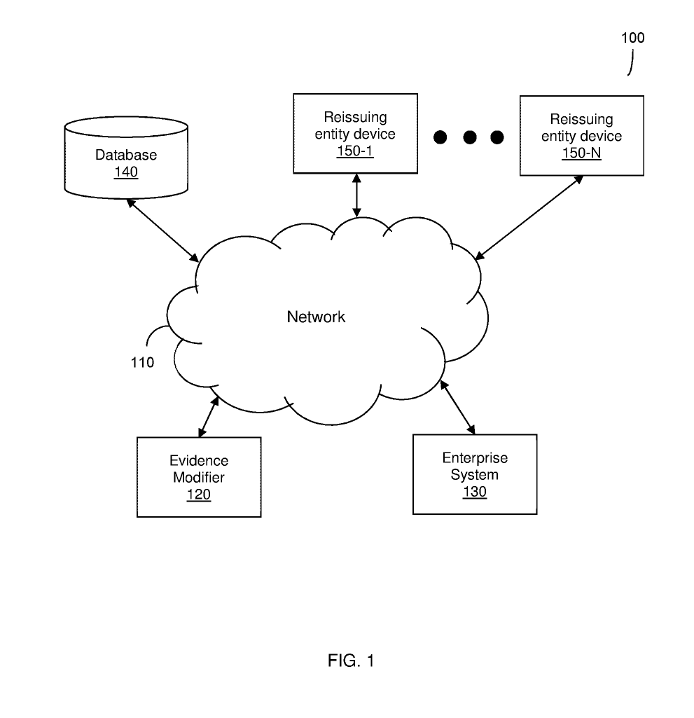

FIG. 1 shows an example network diagram 100 utilized to describe the various disclosed embodiments. In the example network diagram 100, an evidence modifier 120, an enterprise system 130, a database 140, and a plurality of reissuing entity devices 150-1 through 150-N (hereinafter referred to individually as a reissuing entity 150 and collectively as reissuing entities 150, merely for simplicity purposes), are communicatively connected via a network 110. The network 110 may be, but is not limited to, a wireless, cellular, or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or by representatives or employees of the enterprise as well as data related to the enterprise itself. The enterprise system 130 may further store data related to requests (e.g., requests for VAT reclaims or CIT reclaims) to be submitted by the enterprise (e.g., an image file showing a VAT reclaim request form completed by an employee of the enterprise to be submitted to a taxing authority). The enterprise may be, but is not limited to, a business whose employees purchase goods and services subject to VAT taxes while abroad, or whose purchases may be eligible for CIT deductions. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file; a text file; a spreadsheet file; a portable document format (PDF) file; etc.). The contents of the electronic documents may include, e.g., an invoice, a tax receipt, a purchase number record, a VAT reclaim request, a tax report indicating a CIT deduction, and the like. Data included in each electronic document may be at least partially unstructured, i.e., structured, semi-structured, unstructured, or a combination thereof. The structured or semi-structured data may be in a format that is not recognized by the evidence modifier 120 and, therefore, may be treated as unstructured data.

The database 140 may store data utilized by the evidence modifier 120 to optimize the modification of the evidencing electronic documents. Such data may include, but is not limited to, templates created based on evidencing electronic documents, incomplete reissuance request forms, evidencing requirements, matching records, and the like. The evidencing requirements may be further associated with one or more jurisdictions (e.g., one or more countries), uses of evidence (e.g., VAT reclaims, CIT deductions, etc.), a combination thereof, and the like. The evidencing requirements may be retrieved from one or more data sources (not shown), for example, data sources of tax authorities that include rules for requirements of evidencing electronic documents.

The reissuing entity devices 150 are operated by or associated with entities who reissue evidencing electronic documents, or evidences, such as receipts and invoices. As a non-limiting example, the reissuing entity device 150-1 may be a server of a merchant that keeps records of transactions and creates receipts evidencing such transactions. Requests received by the reissuing entity devices 150 from the evidence modifier 120 may be responded to by representatives of the respective reissuing entities via the reissuing entity devices. To this end, a reissuing entity device 150 may be, but is not limited to, a personal computer, a laptop, a tablet computer, a smartphone, a wearable computing device, and the like. In some implementations, the reissuing entity devices 150 may include, or communicate with, a reissue entity server (not shown), and be configured to access requests via the reissue entity server.

In an embodiment, the evidence modifier 120 is configured to create a template based on transaction parameters identified using machine vision of an evidencing electronic document. The evidencing electronic document is an at least partially unstructured electronic document that serves as evidence of a transaction. In a further embodiment, the evidence modifier 120 may be configured to retrieve the evidencing electronic document from, e.g., the enterprise system 130.

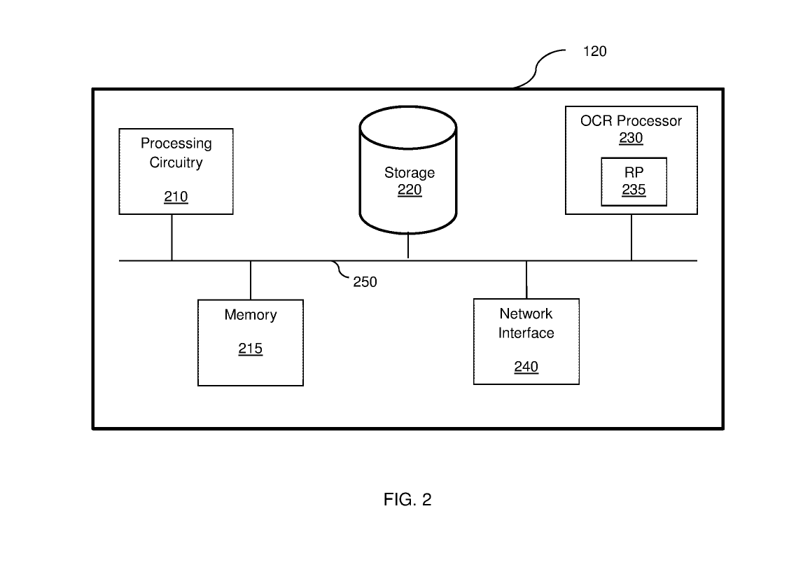

In an embodiment, the evidence modifier 120 is configured to create structured datasets based on electronic documents, including data at least partially lacking a known structure (e.g., unstructured data, semi-structured data, or structured data having an unrecognized structure). To this end, the evidence modifier 120 may be further configured to employ optical character recognition (OCR) or other image processing to determine data in the electronic document. The evidence modifier 120 may therefore include or be communicatively connected to a recognition processor (e.g., the recognition processor 235, FIG. 2).

In an embodiment, the evidence modifier 120 is configured to analyze the created structured datasets to identify transaction parameters related to transactions indicated in the documents. In an embodiment, the evidence modifier 120 is configured to create templates based on the created structured datasets. Each template is a structured dataset including the identified transaction parameters for a transaction.

Using structured templates for determining whether evidencing requirements are met allows for more efficient and accurate determination than, for example, by utilizing unstructured data. Specifically, corresponding evidence requirement rules may be analyzed only with respect to relevant portions of an evidencing electronic document (e.g., only portions included in specific fields of a structured template), thereby reducing the number applications of each rule to the document, as well as reducing false positives due to applying rules to data that is likely unrelated to each rule. Further, data extracted from electronic documents and organized into templates requires less memory than, for example, images of scanned documents.

Based on the created template, the evidence modifier 120 is configured to determine whether the evidencing electronic document meets one or more evidencing requirements. The evidencing requirements include requirements for types of transaction parameters, values of transaction parameters, or both, and may be requirements for purposes such as, but not limited to, obtaining a refund (e.g., via a VAT reclaim) or a deduction (e.g., a deduction for CITs). The evidencing requirements may be included in sets, where each set is associated with a different use of the evidencing electronic document, jurisdiction in which the transaction occurred, or both. As a non-limiting example, when the evidencing electronic document is to be utilized as evidence to support a CIT deduction, the evidencing requirements may include required transaction parameters for a country of the transaction indicated in the evidencing electronic document. In an embodiment, the evidencing requirements are identified by accessing requirements issued by a taxing authority.

When it is determined that the evidencing electronic document does not meet the evidencing requirements (e.g., if one or more of the required transaction parameters as defined in the rules is missing from the evidencing electronic document), the evidence modifier 120 is configured to retrieve a matching record of the transaction and to generate a modified version of the evidencing electronic document based on the retrieved matching record of the transaction. The modified version includes the missing required parameters that are present within the matching record. The matching record may include reports, submissions, and the like, detailing the same transaction represented by the evidencing electronic document, and stored within a database of an entity, e.g., within the enterprise system 130. To this end, the evidence modifier 120 is configured to retrieve the matching record based on one or more transaction parameters in the template that uniquely identify the transaction of the evidencing electronic document (e.g., transaction number, date plus time, etc.). The modified version may then be sent to a reissuing entity for reissue.

For example, the evidence modifier 120 may analyze an evidencing electronic document for the purchase of a hotel stay, e.g., a scanned receipt issued by the hotel. It is determined that the evidence is to be used for a VAT refund and that, based on evidencing requirements of a tax authority to which the VAT refund will be submitted (e.g., a tax authority associated with the country in which the transaction occurred), any evidence to be used for a VAT refund is required to include a transaction date. The evidence modifier 120 creates a template based on the scanned receipt. It is determined that a “date” field of the template has a null value (i.e., the transaction date is missing).

When it is determined that the required parameter transaction date is missing from the template, evidence modifier is configured to determine the missing date by retrieving a matching record and identifying the transaction date therein. The evidencing electronic document is then modified by the evidence modifier 120 to include the retrieved missing date, e.g., by stamping the evidence with the missing date in a conspicuous manner. The modified evidence may then be sent to a reissuing entity (e.g., the supplier of the good), with a request for reissuance of the evidence including the identified transaction date.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the evidence modifier 120 according to an embodiment. The evidence modifier 120 includes a processing circuitry 210 coupled to a memory 215, a storage 220, and a network interface 240. In an embodiment, the evidence modifier 120 may include an optical character recognition (OCR) processor 230. In another embodiment, the components of the evidence modifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, configure the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a structured dataset including data required for verification of a request.

The network interface 240 allows the evidence modifier 120 to communicate with the enterprise system 130, the database 140, the reissuing entity devices 150, or a combination thereof, for the purpose of, for example, retrieving evidencing electronic documents and evidencing requirements, storing created templates, sending optimized requests, and the like.

It should be understood that the embodiments described herein are not limited to the specific architecture illustrated in FIG. 2, and other architectures may be equally used without departing from the scope of the disclosed embodiments.

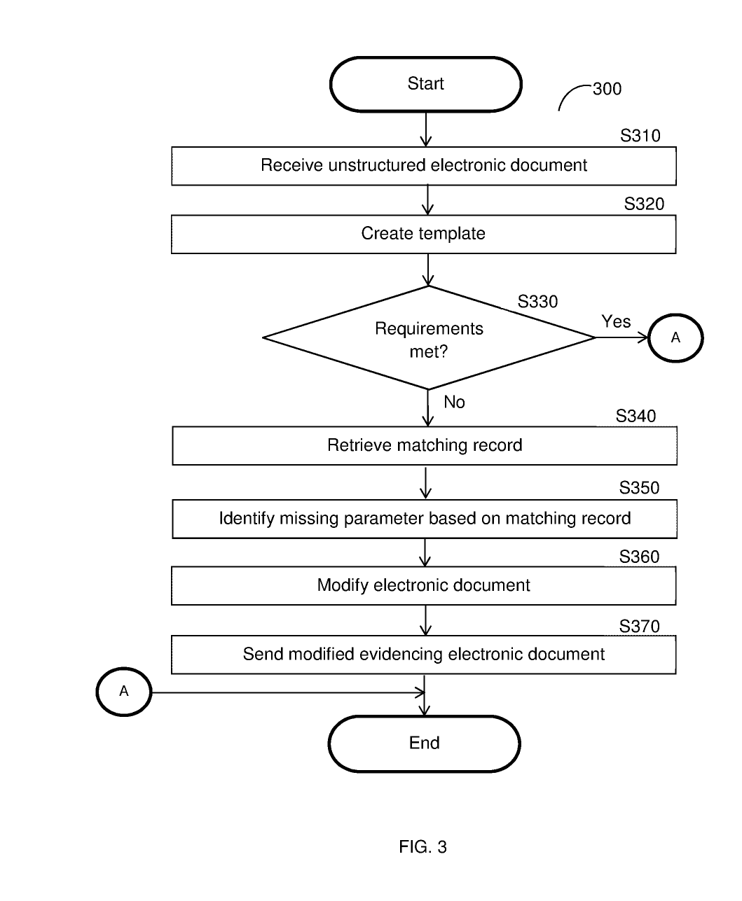

FIG. 3 is an example flowchart 300 illustrating a method for modifying an evidencing electronic document according to an embodiment. In an embodiment, the method is performed by the evidence modifier 120 of FIG. 1.

At S310, an evidencing electronic document is received. The evidencing electronic document is at least partially unstructured. In an embodiment, S310 may further include receiving an indication of an intended use for the evidencing electronic document. The intended use may be, for example, to support a CIT deduction or VAT reclaim.

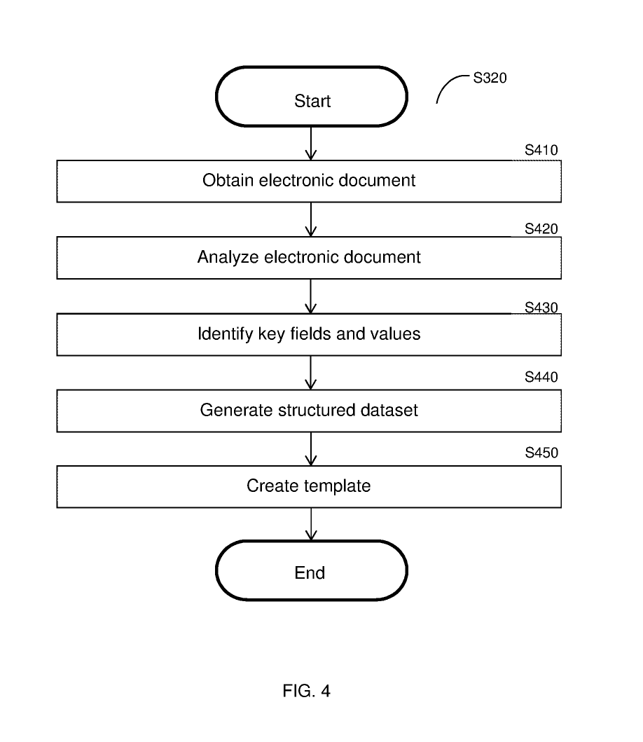

At S320, a template is created based on the received evidencing electronic document. The template is a structured dataset including key fields and values identified in the evidencing electronic document. Creating templates for unstructured electronic documents is described further herein below with respect to FIG. 4 and in U.S. patent application Ser. No. 15/361,934, assigned to the common assignee, the contents of which are hereby incorporated by reference.

At S330, based on the created template, it is determined if the evidencing electronic document meets one or more evidencing requirements and, if so, execution continues with S340; otherwise, execution terminates. The evidencing requirements to be met may be determined based on the intended use, or may be a default set of requirements. The evidencing electronic document may fail to meet an evidencing requirement if, for example, a field of the template corresponding to the evidencing requirement has a null or otherwise invalid value. As a non-limiting example, if the requirements include a price of the transaction and a “price” field of the template has a null value, it may be determined that the evidencing electronic document does not meet the price requirement. In an embodiment, the evidencing requirements may be retrieved from an external source, e.g., a tax authority database.

At S340, a matching record is retrieved. The record includes transaction parameters related to the same transaction indicated by the evidencing electronic document. A record may be determined to be a matching record if it is determined to be similar to the evidencing electronic document above a predetermined threshold. Specifically, a record may be a matching record if one or more values of uniquely identifying transaction parameters are identified in both the evidencing electronic document and in the record. For example, a matching record may include an employee report submitted to an employer entity, where the employee report is a submitted form detailing the same transaction as represented by the evidencing electronic document, e.g., a receipt of a sale of goods happening on the same date and concerning the same type of goods.

The matching report may be an electronic document or other dataset including transaction parameters. In an embodiment, S340 includes identifying transaction parameters of records and comparing the identified record transaction parameters to the uniquely identifying transaction parameters of the evidencing electronic document.

At S350, one or more missing parameters is identified in the matching report. Each missing parameter is a transaction parameter that is required. For example, if a required transaction parameter (i.e., a transaction parameter indicated in the evidencing requirements) is identified within the matching report, but is missing from the evidencing electronic document, it is identified as a missing parameter. Continuing with the aforementioned example, if the matching record indicated a price of $5,000 for a required transaction parameter “price” and the evidencing electronic document contains a null value of the “price” transaction parameter, the price of $5,000 is identified as the missing parameter.

At S360, the evidencing electronic document is modified to include the identified missing parameters. The modified evidencing electronic document includes the information in the analyzed evidencing electronic document as well as the missing parameters.

At optional S370, the modified evidencing electronic document is sent to a recipient, e.g., a reissuing entity. The modified evidencing electronic document may be sent as part of a reissue request. In an embodiment, S370 may include determining, based on the created template, a reissuing entity for the transaction (e.g., a merchant indicated in a “seller” field of the template) and retrieving contact information associated with the determined reissuing entity. For example, if a supplier “ABC Company” is determined to be the appropriate reissuing entity for a particular evidencing electronic document, a request for reissuance including the modified evidencing electronic document may be sent to, for example, an email address associated with ABC company.

As a non-limiting example, a scanned receipt of a transaction in Germany to be utilized as evidence for a VAT reclaim is analyzed and a template is created for the receipt. The template is compared to evidencing requirements of a tax authority in Germany, and based on the comparison it is determined that the evidencing electronic document is missing a required transaction parameter “date.” A matching report is retrieved, and a date is identified in the matching report. The evidencing electronic document is modified to include the required data, for example, a portion of text stating “Date of transaction: 12/12/2010” may be stamped on the evidencing electronic document. The modified evidencing electronic document is sent, via email, to an email address associated with a seller indicated in the template.

FIG. 4 is an example flowchart S320 illustrating a method for creating a template based on an electronic document according to an embodiment.

At S410, the electronic document is obtained. Obtaining the electronic document may include, but is not limited to, receiving the evidencing electronic document (e.g., receiving a scanned image of a receipt) at S310.

At S420, the electronic document is analyzed. The analysis may include, but is not limited to, using optical character recognition (OCR) to determine characters in the electronic document.

At S430, based on the analysis, key fields and values in the electronic document are identified. The key fields may include, but are not limited to, a merchant's name and address, a date of a transaction, currency used, a good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, the cleaning process can change the name to “Mosden.” The cleaning process may be performed using external information resources, such as dictionaries, calendars, and the like.

In a further embodiment, it is checked if the extracted pieces of data are complete. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated structured dataset includes the identified key fields and values.

At S450, based on the structured dataset, a structured dataset template is created. The created template is a data structure including a plurality of fields and corresponding values. The corresponding values include transaction parameters identified in the structured dataset. The fields may be predefined.

In an embodiment, creating the template includes analyzing the structured dataset to identify transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the structured dataset may also include identifying the transaction based on the structured dataset.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a modified evidencing electronic document including missing elements based on an electronic document including at least partially unstructured data, comprising:
analyzing the electronic document to determine at least one transaction parameter;
creating a template for the electronic document, wherein the template is a structured dataset including the at least one transaction parameter;
determining, based on the template, whether the electronic document meets at least one evidencing requirement;
identifying at least one missing parameter based on a matching record when it is determined that the electronic document does not meet the at least one evidencing requirement; and
generating the modified evidencing electronic document including the identified at least one missing parameter.

2. The method of claim 1, wherein determining the at least one transaction parameter further comprises:
identifying, in the electronic document, at least one key field and at least one value;
creating, based on the electronic document, a structured dataset, wherein the created structured dataset includes the at least one key field and the at least one value; and
analyzing the created structured dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, wherein the electronic document does not meet the at least one evidencing requirement when the template does not include at least one required transaction parameter indicated in the at least one evidencing requirement.

6. The method of claim 1, wherein the matching record includes at least one transaction parameter that matches at least one uniquely identifying transaction parameter in the template.

7. The method of claim 1, wherein the at least one evidencing requirement is determined based on an intended use of the electronic document.

8. The method of claim 7, wherein the intended use is at least one of: evidence for a value-added tax (VAT) reclaim, and evidence for a corporate income tax (CIT) deduction.

9. The method of claim 1, further comprising:
sending the modified evidencing electronic document in a request for reissue.

10. A non-transitory computer readable medium having stored thereon instructions for causing a processing circuitry to perform a process for generating a modified evidencing electronic document including missing elements based on an electronic document including at least partially unstructured data, the process comprising:
analyzing the electronic document to determine at least one transaction parameter;
creating a template for the electronic document, wherein the template is a structured dataset including the at least one transaction parameter;
determining, based on the template, whether the electronic document meets at least one evidencing requirement;
identifying at least one missing parameter based on a matching record when it is determined that the electronic document does not meet the at least one evidencing requirement; and
generating the modified evidencing electronic document including the identified at least one missing parameter.

11. A system for generating a modified evidencing electronic document including missing elements based on an electronic document including at least partially unstructured data, comprising:
a processing circuitry; and
a memory, the memory containing instructions that, when executed by the processing circuitry, configure the system to:
analyze the electronic document to determine at least one transaction parameter;
create a template for the electronic document, wherein the template is a structured dataset including the at least one transaction parameter;
determine, based on the template, whether the electronic document meets at least one evidencing requirement;
identify at least one missing parameter based on a matching record when it is determined that the electronic document does not meet the at least one evidencing requirement; and
generate the modified evidencing electronic document including the identified at least one missing parameter.

12. The system of claim 11, wherein the system is further configured to:
identify, in the electronic document, at least one key field and at least one value;
create, based on the electronic document, a structured dataset, wherein the created structured dataset includes the at least one key field and the at least one value; and
analyze the created structured dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the electronic document.

15. The system of claim 11, wherein the electronic document does not meet the at least one evidencing requirement when the template does not include at least one required transaction parameter indicated in the at least one evidencing requirement.

16. The system of claim 11, wherein the matching record includes at least one transaction parameter that matches at least one uniquely identifying transaction parameter in the template.

17. The system of claim 11, wherein the at least one evidencing requirement is determined based on an intended use of the electronic document.

18. The system of claim 17, wherein the intended use is at least one of: evidence for a value-added tax (VAT) reclaim, and evidence for a corporate income tax (CIT) deduction.

19. The system of claim 11, wherein the system is further configured to:
send the modified evidencing electronic document in a request for reissue.
